(19) United States
(12) Patent Application Publication
(10) Pub. No.: US 2003/0115096 A1
(43) Pub. Date: Jun. 19, 2003

(54) Computer-controlled, remotely programmed at-shelf advertising system

(76) Inventors: Randy B. Reynolds, Salt Lake City, UT (US); James V. Yardley, Centerville, UT (US)

Correspondence Address: Mr. Lynn G. Foster, Foster & Foster, LLC, 602 E. 300 S., Salt Lake City, UT, 84102, US

(21) Appl. No.: 10/052,172

(22) Filed: Jan. 17, 2002

Related U.S. Application Data
(63) Continuation-in-part of application No. 10/024,082, filed on Dec. 17, 2001.

(51) Int. Cl. G06F 17/60

(52) U.S. Cl. 705/14

(57) ABSTRACT

A novel shelf-borne programmable, display assembly which communicates with a remote controller to provide wireless, dynamically variable though unattended, point-of-purchase advertising. The display assembly is normally extended transversely into a shopping aisle and may provide independent advertising on two sides of computer controlled graphic displays. Point-of-purchase advertising is generated, sent and controlled from a remote controller, preferably through wireless bi-directional communications. Further, the display assembly employs a low-power, low cost computer and associated electronics to store and display advertisements, monitor surroundings using audio and video receivers and interrogate RF tag readers. Of particular value is a capability of performing a real-time, labor-free inventory, taken of shelf-resident products marked by remotely readable tag-identifiers. Power consumption is minimized using motion sensing and an associated power down sleep circuit. A unique shelf attachment mechanism applies a battery and associated weight to a shelf and secures and protects the battery from theft.

### CONTINUATION

This is a continuation-in-part of U.S. patent application Ser. No. 10/024,082, filed Dec. 17, 2001 by Randy Reynolds entitled POINT-OF-PURCHASE ADVERTISING BY A CANTILEVERED DISPLAY MECHANISM WITH AN UNDER-THE-SHELF BATTERY AND RELATED METHODS (Docket 8324).

### FIELD OF INVENTION

The present invention relates generally to shelf-based, point-of-purchase product advertising and more particularly to such advertising which singles out to the consumer one product over others; which extends generally transversely (perpendicular) into a shopping aisle in a grocery store, supermarket, a discount center or the like, which uses deflectable cantilevered display mechanisms comprising a shelf borne battery and which is controlled and modified via a remotely disposed controller to provide an attention-getting hands free, real time, dynamically variable display for shoppers.

### BACKGROUND

The power of point-of-purchase advertising in grocery stores and similar shelf-based businesses is well known in the self-service industry. Manufacturers and merchants employ a wide range of point-of-purchase advertising techniques to attract and entice customers to purchase self stored items. As the point-of-purchase is generally the last decision point in a buying decision, the quest to impact those last decisive moments before a purchase is elected and a product is removed from a shelf relies greatly upon catching the eye of a consumer.

Economics of in-store merchandising is dependent upon point-of-purchase advertising cost balanced against effectiveness (relative increase in volume of sales) achieved by such advertising. U.S. Pat. No. 6,202,334 B1, issued Mar. 20, 2001 to Reynolds et al., one of whom is a present inventor, discloses the following three key factors of point-of-purchase advertising:

(1) the extent to which the attention of prospective customers is attracted directly and meaningfully to the product receiving the target advertising over and above other available products;

(2) the comparative cost of the advertised product; and

(3) the cost and convenience of installing, maintaining and varying the target advertising.

Contemporary advertising, disposed in close proximity to an advertised product is commonly taught in prior art to be static in nature and relies upon color, artistry, illumination, advertised price shelf location and/or luck to attract a customer. While transversely disposed advertising, of which the mechanism and related methods of the above-mentioned U.S. patent application Ser. No. 10/024,082, is an example, is generally considered to be more eye-catching than advertising which is disposed flush with a shelf, most current point-of-purchase advertising comprises static, relatively unchanging signboards.

In addition, point-of-purchase advertising generally depends upon manual intervention to change any particular signboard. This imposes an inherent time burden, cost function and a significant lack of convenience for manufacturers and store operators to maintain and update in-store point-of-purchase advertising. Similarly, continuously electrically powered advertising, such as that using illuminated displays, which are remote and which rely upon some form of stored power, such as batteries, can wastefully discharge the power source when there is no consumer in view. Loss of illumination does negatively impact effectiveness of advertising display and replacing discharged batteries, or the like, can place an unduly high service cost upon those who monitor such displays.

Timely knowledge of effectiveness of a particular advertising campaign is critical to a manufacturer's marketing strategy. Current feedback of information on the effectiveness of a particular advertising campaign often relies upon product reorders, direct contact with stores or visits by representatives of manufacturers. Lag time associated with this type of feedback can be costly when measured by the effectiveness of a manufacturer's and/or store operator's response to product market dynamics.

Further, as point-of-purchase advertising devices become targets of theft, consideration must be given to assure security of such devices. Remote monitoring has not been available for security purposes nor has it been the status, of the advertising device, the current shelf inventory, the product removal rate and other related marketing data pertaining to the point-of-purchase site.

### BRIEF SUMMARY AND OBJECTS OF THE PRESENT INVENTION

Duly considering the foregoing, the present invention overcomes or substantially alleviates problems of prior art and provides novel solution for remotely controlled, dynamic, hands-free, illuminated point-of-purchase advertising.

In brief summary, the present invention relates to: (a) a point-of-purchase advertising display assembly (display assembly) which is preferably releasibly secured to a shelf in a retail store in close proximity to a specific product being advertised and (b) a controlling computer system (controller) which is disposed at a location remote from the shelf unit. Generally, advertising media and other shelf unit control information originates at the controller and is downloaded via spacial communications into the display assembly from the remote controller. These communications are preferably wireless, including but not limited to cell phone links. The controller computer has capacity to service a plurality of remote point-of-purchase display assemblies.

The display assembly comprises a low-power computer processor having adequate memory to accommodate display, control and communications programs. In addition, the display assembly comprises at least one graphics display, which is preferably transversely disposed relative to the shelf to thereby project perpendicularly into an adjoining aisle for easy visibility.

The shelf unit and its display may be cantilevered and deflectable, for example only, as disclosed in the above-mentioned U.S. patent application Ser. No. 10/024,082, which is incorporated herein by reference. For bidirectional visibility, when approached along the aisle from either direction, the display assembly may comprise back-to-back or two sided graphic displays. Physical size of the display is dependent upon application and space available at the point-of-purchase site, but no more than a relatively small projection into the aisle should occur. In addition, the display assembly may be provided with speaker capability for auditory presentations.

The shelf unit is securely although releasibly affixed to the edge of a retail shelf via a molding clamp, an example of which is disclosed in the above mentioned U.S. patent application Ser. No. 10/024,082. A power supply (e.g. a battery) is securely affixed under the shelf and behind the molding or elsewhere on or in close proximity to the illumination system of the display assembly. As both the display assembly and the battery may be a target for theft, the fastened relation should be as secure as possible.

To reduce the power required for operation of the shelf unit, a motion detection system may be used to switch the illumination of th display off and on. Thus, only when a moving object (consumer) is within a reasonable viewing distance (e.g. thirty feet) does the shelf unit become illuminated. When the display assembly has two oppositely directed graphic displays, two motion detectors may be used to selectively activate illumination on one or both sides of the display depending on whether shoppers are in the aisle on one or both sides, to conserve power.

To provide real time consumer traffic information and rate-of-product-purchase data at the point-of-purchase display site, the display assembly may be furnished, first, with a video camera and, second, with an inventory tracking system. While the video camera is primarily intended for use in recording and transmitting information back to the controller, traffic and other sales related activity along the aisle, a live video/audio sequence may be periodically provided on the display, as an eye catching product-identifying tactic. The inventory tracking function is preferably accomplished via an RFID-RF tag identification system. By providing RFID-RF tags or other transponders, affixed to or otherwise associated with the product or its packaging, presence of individual products or packages can be sensed and inventoried at the shelf by wireless communication between the products or packages and the display assembly. Rate of removal of product from shelf (purchase rate) is acquired by periodic scanning the region above the shelf and sending the scanned information to the controller, where the manufacturer of the product being advertised can analyze sales in real time. In addition, the video camera may be augmented with a microphone to capture sounds along the aisle. The display assembly may also comprise a speaker for audio transmission.

The remote controller communicates with each display assembly by wire or, preferably, wirelessly, which may entail use of cell phone links. The controller may be comprised of a commercially available server system. The controller communicates with one or more shelf display assemblies to provide functions which modify advertising display, monitor aisle activity, acquire inventory data acquisition and generally interact with the shelf disposed display assemblies to provide a real time link spatially between a manufacturer's representative and the remotely located point-of-purchase.

With the foregoing in mind, it is a primary object to overcome or substantially alleviate problems of the past in the field of at-the-shelf retail display assemblies. It is a significant object to provide novel retail shelf display systems and related methods. It is another primary object to provide a programmable, display assembly securely and transversely affixed to a shelf upon which a product is stored for sale, which assembly wirelessly communicates with a remote controller to provide variable point-of-purchase advertising.

It is a fundamental object to provide a point-of-purchase programmable, display assembly which is deflectably cantilevered into an aisle.

It is another primary object to provide a controller in combination with a remotely disposed point-of-purchase advertising display assembly, where advertising originates at the controller and is visible at the point-of-purchase advertising assembly.

It is an important object to provide a point-of-purchase display assembly which is combined with a low-power, low cost computer with memory to store advertising displays, communications and control programs and data acquired by the computer.

It is another valuable object to provide a computer-controlled retail shelf advertising display comprising at least one graphics display; a power supply; and a shelf-mounting mechanism system whereby the display assembly is securely though releasibly affixed to the shelf, the power supply being carried by the shelf such that weight of the power supply is not borne by the portion of the display assembly which extends into the aisle.

It is an important object to provide a display assembly having a battery for a power supply in combination with a computer controller.

It is a significant object to provide a molding clamp apparatus for a compute controlled, shelf-mounted display assembly which securely affixes the display assembly to the shelf.

It is also another valuable object to provide an under-the-shelf and behind-the-molding storage place for the battery comprising part of a computer-controlled retail shelf advertising display.

It is an object to provide a retail shelf display assembly in combination with a video camera disposed to capture images from an aisle alongside the display shelf.

It is an object to store such images for future display in a memory of the display assembly.

It is an object to selectively send video images taken by the video camera to a controller.

It is an object to selectively present real-time video images taken by the video camera on at least one graphics display.

It is an object to provide a retail shelf display assembly which may comprise a microphone to permit recording point-of-sale audio from shoppers.

It is an object to provide a retail shelf display assembly comprising a speaker which permits controlled emission of advertising audio from the display assembly.

It is an important object to preserve power in a retail shelf display assembly when a consumer is not near.

It is an object to provide at least one motion detector as part of a retail shelf display assembly which motion detector detects movement along the aisle to activate illumination at the display.

It is an object, to provide a switchable sleep circuit which, when activated, selectively provides power to a retail shelf display assembly and, when deactivated shuts off power to the display assembly.

It is an object to provide a timer which times out to deactivate or activate a sleep circuit by which electrical power is provided to a retail shelf display assembly.

It is likewise an object to provide a plurality of motion detectors and a sleep circuit with switching options to selectively control power to more than one graphics retail display shelf so that power may be conserved.

It is a highly valued object to provide a product identification system whereby a real-time, labor-free inventory is taken periodically of a product resting on a retail shelf which are marked by remotely accessible identifiers comprising at least one identifier from a group of identifiers comprising tags, transponders and other markers which are responsive to interrogating signals from an identification system.

It is a basic object to provide a retail shelf display assembly comprising two juxtaposed graphic displays oriented so that video images are seen from two opposing directions along a shopping aisle.

It is a major object to provide a plurality of retail shelf display assemblies associated with a single controller.

It is a fundamental object to provide a method for achieving hands free, programmable attention-getting advertising along an aisle of a self-service retail store.

It is still another fundamental object to provide a method for affixing a power supply of a retail shelf display assembly to the shelf such that weight of the power supply is not borne by the portion of the display assembly which extends into the aisle.

It is a significant object to selectively turn off electrical power to a retail shelf display assembly to conserve power when there is no movement along an aisle.

It is an object to provide a product identification system and method whereby a real-time, hands-free inventory is taken of shelf stored products marked by remotely accessible identifiers comprising at least one identifier from a group of identifiers comprising tags, transponders and other markers which are responsive to interrogating signals from the identification system.

These and other objects and features of the present invention will be apparent from the detailed description taken with reference to accompanying drawings.

### BRIEF DESCRIPTION OF THE DRAWINGS

FIG. 1 is a perspective of one of several possible computer or remotely controlled display assemblies;

FIG. 2 is a vertical cross section through the proximal portion of the display assembly of FIG. 1, taken along lines 2-2;

FIG. 3 is a block diagram of an exemplary combination, according to the principles of the present invention, comprising retail display assemblies and remote server and system controller;

FIG. 4 is a schematic block diagram of a shelf-attachable display assembly, a remote controller, a motion detector, an audio feature, a video camera and illuminated graphics at the display;

FIG. 5 is a perspective of a remotely controlled shelf-attachable display assembly according to the present invention;

FIG. 6 is an enlarged side elevation of the shelf-attachable display assembly of FIG. 5 with the proximal shelf-clamping portion removed;

FIG. 7 is an enlarged side elevation of the opposite side of the shelf-attachable display assembly shown in FIGS. 5 and 6, with the proximal shelf-clamping portion removed;

FIG. 8 is an exploded bottom perspective of the shelf-attachable display assembly of FIGS. 5 and 6;

FIG. 9 is a cross section taken along lines 9-9 of the display assembly seen in FIG. 5;

FIG. 10 is a program flow chart of a startup phase for an initialization (booting) portion of a system controller;

FIG. 11 is a program flow chart of a main communications loop of a system controller;

FIG. 12 is a program flow chart of a startup phase for an initialization (booting) portion of a display assembly;

FIG. 13 is a program flow chart of a main control loop of a display assembly;

FIG. 14 is a program flow chart of a self test loop of a display assembly;

FIG. 15 is a program flow chart of a continuation of the self test loop of FIG. 14;

FIG. 16 is a program flow chart of wireless communication operation of a display assembly;

FIG. 17 is a program flow chart of a continuation of the wireless communication operation of FIG. 16;

FIG. 18 is a program flow chart of a camera operation control sequence for a display assembly;

FIG. 19 is a program flow chart of a motion detection program flow for a motion detector of a display assembly;

FIG. 20 is a program flow chart of an inventory detection and updating sequence through the use of an RFID subsystem in a display assembly; and

FIG. 21 is a program flow chart of an inventory updating sequence of a display assembly.

### DETAILED DESCRIPTION OF THE ILLUSTRATED EMBODIMENTS

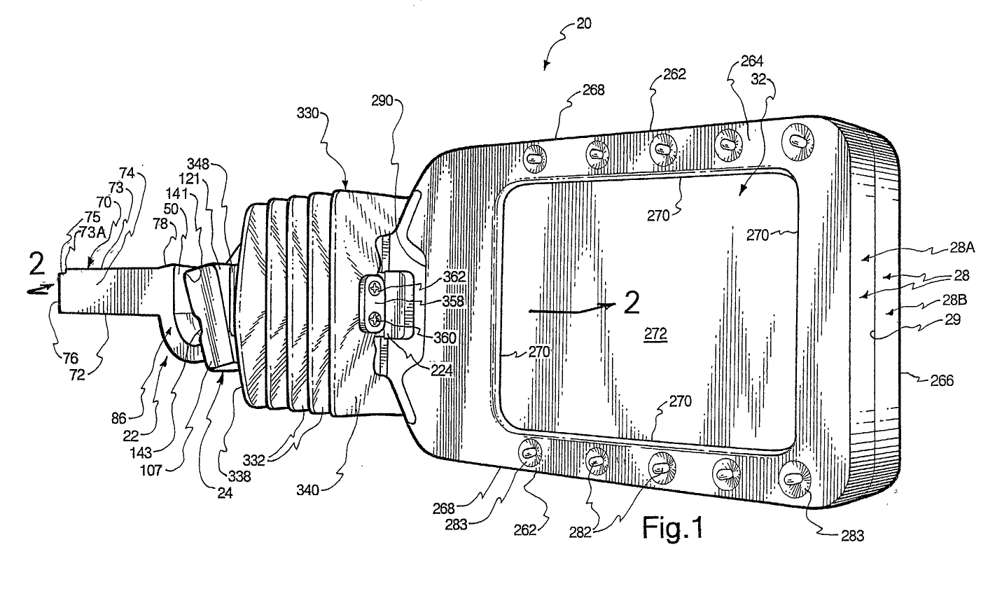

In this description, the term proximal is used to indicate the segment of a part or device closest to an associated shelf or to the object of the sentence describing its position. The term distal refers to the opposite. Reference is now made to the embodiments illustrated in FIGS. 1-21, where like numerals are used to designate like parts throughout.

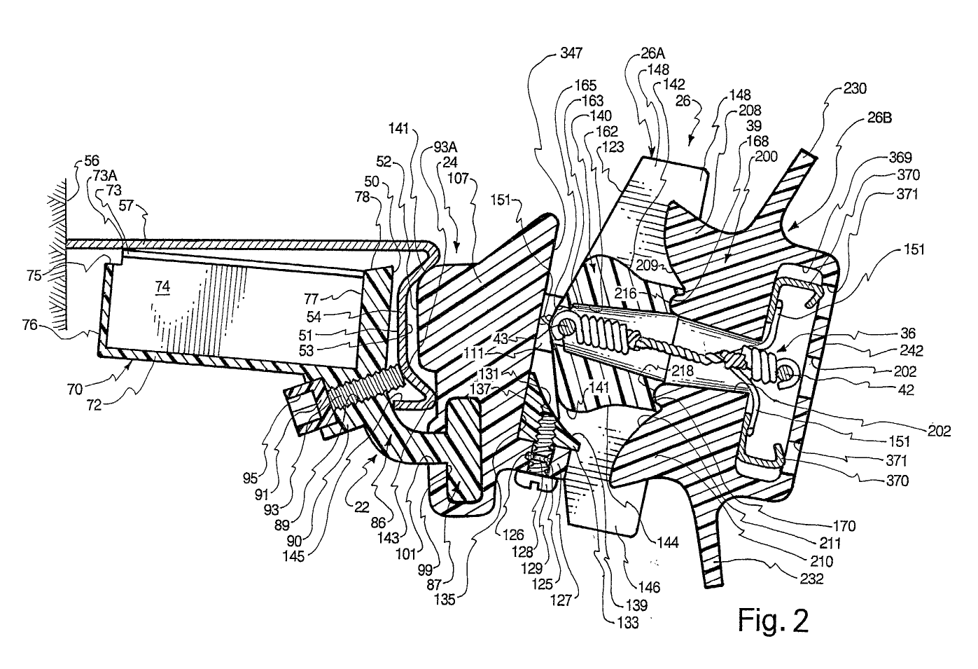

Reference is now made to FIGS. 1 and 2. Seen in FIGS. 1 is an illustration of a cantilevered deflectable illuminated display assembly, generally designated 20, which, when releasibly attached to a retail shelf (upon which an inventory of product is stored for purchase), extends perpendicularly into a associated shopping aisle. Display assembly 20 is fully disclosed in above-mentioned U.S. patent application Ser. No. 10/024,082, and is incorporated herein in its entirety by reference. FIG. 2 is a vertical cross section through the proximal portion of the display assembly 20 of FIG. 1.

Such displays are intended for use along shopping aisles in retail stores, including but not limited to grocery stores, supermarkets, pharmacies, discount centers and the like. While displays, similar to display 20, are constructed so as to obtain singular attention of shoppers in such a way that the product which is the target of advertising displayed on the assembly, the advertising is static and requires manual intervention to change the advertisement. In prior retail advertising displays, the advertising portion is static and requires manual intervention to change the advertisement. Such display assemblies are securely affixed to the shelf and permit temporary deflections out of the perpendicular or neutral position when driven by an external force, such as impact by a person or a shopping cart. Such deflections permit traverse extension a very short distance into the aisle in the neutral position without significant risk of injury or property damage.

Assembly 20 is comprised of two proximal mounting members or connectors, generally designated 22 and 24. Proximal to the shelf, member 22 is a first clamping member and member 24 forms a base or second clamping member, neither of which rotate or deflect out of the way when a distally-disposed segment of display assembly is impacted by or receives an external force from cart or human movement along the aisle. Display assembly 20 further comprises a hanger segment, generally designated 26 (best seen in FIG. 2), comprised of two hanger elements 26A and 26B, and a display or frame segment, generally designated 28 (which is seen in FIG. 1). Frame 28 peripherally encircles advertising material.

The clamping or mounting members 22 and 24 are collectively comprised of upwardly directed surfaces 50 and 52 (see FIG. 2), which are respectively juxtaposed to rear and front surfaces 51 and 53 of a molding edge strip 54 comprising a front depending portion of a shelf 57. The display assembly 20 is supported by the molding 54. The molding or channel 54 may be formed of a suitable metal and is anchored at abutment 56. Abutment 56 may comprise the end of a shelf or the face of a refrigerator or cabinet or some other location along a shopping aisle of a grocery or other store.

As is disclosed in the above-mentioned U.S. patent application Ser. No. 10/024,082, it is an important feature to provide a display assembly or mechanism for point-of-purchase utilization along a shopping aisle such that the advertising presented by the display assembly can be materially altered from time-to-time in its nature, configuration, and content, as desired by the manufacturer of products subject to the advertising and/or by store management. However, it should be noted that such alteration of advertising heretofore has required manual intervention and no method of or mechanism for remotely and automatically changing advertising have been provided.

The proximal mounting member 22 is illustrated in FIG. 2 as essentially comprising a one piece element formed by injection or another conventional molding technique using a suitable rigid, non-frangible, impact resistant synthetic resinous material. One end of the proximal mounting member 22 comprises a box-shaped frame 70 defined by a bottom wall 72, spaced and substantially identical, though opposite hand, sidewalls 74 (only one of which is seen in FIG. 2), a backwall 76 and a front reinforced wall 78. Walls 72, 74 and 76 are illustrated as being planar and of essentially uniform thickness. Top edges of wall 76 and top inwardly directed lips of walls 74 accommodate insertion of a top plate (not seen but fully disclosed in the above-mentioned U.S. patent application Ser. No. 10/024,082. The top plate essentially closes the open top of box-shaped receptacle 70.

Thus, a closed, secure compartment is provided by receptacle 70 for one or more batteries, such as battery 572. Conductors are connected to the battery and extended for distal access through a slider bar 87 to provide electrical power via wires 151, seen in FIG. 2.

Mounting member 24 comprises essentially a body of material 107. The mounting member 24 functions together with member 22 as a clamp to engage the molding strip 54, front and back, respectively, as shown in FIG. 2. Mounting member 24 also functions to receive mounting member 22, as previously disclosed. In this manner, display assembly 20 is securely affixed to molding strip 54 and at least one a battery 572 is disposed within receptacle 70. Mounting member 24, like most of the components of assembly 20, is preferably formed of non-frangible, impact resistant, durable synthetic material, such as ABS, and may be formed by known methods of plastic molding, including, but not limited, to injection molding.

Because return mechanisms may comprise coil springs and because hanger member 26B pivots into an open relationship in respect to hanger member 26A, in some configurations of display assembly 20, an elastomeric protective boot 330 may be placed so as to surround those portions of the assembly which open during pivoting, to prevent injury to a child or other passerby and to prevent contamination from dirt or other debris. A suitable boot 330 for this purpose is illustrated in FIG. 1. While boot 330 is illustrated as being in bellows or pleated form, other configurations may be used. Boot 330 may be adhered at its ends to appropriate locations around the periphery of members 26A and 26B. Boot 330 may, alternatively, be stretched into its protective position. No matter how installed, boot 330 shields portions of display assembly 20 which create openings when the distal pivoted portion of assembly 20 is pivoted in respect to the proximal portion of the assembly.

Boot 330, in the illustrated configuration, is formed of a suitable elastomeric material and sized to be stretched and pulled into position over members 26A and 26B, after members 26A and 26B are assembled. Boot 330 comprises a plurality of bellows 332, a hollow interior 334.

Flanged ends are formed, sized and disposed for ready connection to proximal and distal parts of assembly 20. Flanges 224 and 226 (flange 224 is seen in FIG. 1) function as stops to limit lateral pivotal displacement in either direction to essentially 90 degrees. Assembly 20 is affixed to boot 330 via flat steel or plastic bars 358.

Other numbers seen in FIGS. 1 and 2 enumerate parts which detail items, attachments and features of assembly 20 and which are explained in detail in the above-identified U.S. patent application Ser. No. 10/024,082.

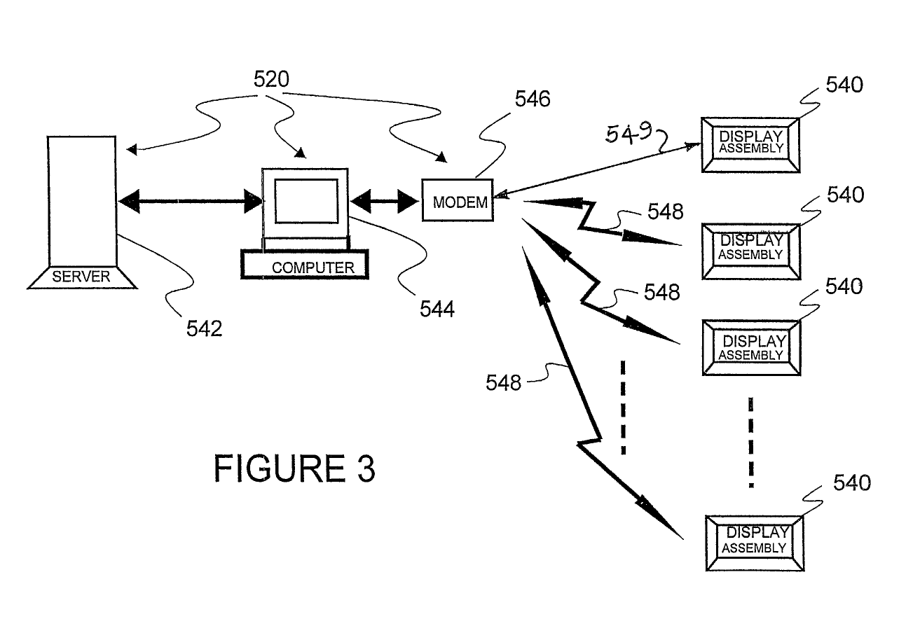

Reference is now made to FIG. 3, which illustrates a system according to the instant invention, comprised of at least two subsystems, a controlling computer subsystem (generally designated controller 520) and at least one display assembly, generally designated 540. Controller 520 communicates with a plurality of display assemblies, each designated 540. Each display assembly 540, during normal use, is remotely disposed relative to controller 520. Further, each assembly 540 is securely affixed, connected or mounted to a shelf, as explained above, in close proximity to a shelf-borne item available on the shelf for selection and purchase.

The controlling subsystem 520 comprises a server 542, a system control computer 544 and a modem or equivalent communications driver 546. Remotely generated or created advertising information that is to be utilized in each display assembly 540 is first organized and electronically stored in controller 520. Thus, controller 52 is a source of electronic advertising information. Such information is typically advertising, which may be in the form of graphics files, video files, audio files and HTML/XML files. HTML files are generally programs which, when downloaded to a display assembly 540, control operation, sequencing, timing and overall functioning of the receiving display assembly. Graphics files, video files, audio files and transmission of written information are readily controlled and sequenced to produce effective media advertising through the use of standard HTML/XML programs for controlling Internet Browser applications, which run on one or more display assemblies. One skilled in the Internet art well understands generation, organization and transmission of such applications. Though not necessary within the scope of the instant invention, use of browser based programs, common to web based programming, is an effective method of programming and controlling sequencing of a display assembly 540, where product advertising is displayed in human readable form.

Files are readily downloaded wirelessly to each display assembly 540 from controller 520 via a phone link, generally numbered 548, or by hard wire 549. In like manner, other files may be readily downloaded from a display assembly 540 to controller 520. The phone links for transmission of advertising information 548 may be made via wired (e.g. phone) as at 549 or wireless (e.g. cell phone) transmissions as at 548. As disclosed in detail hereafter, each display assembly 540 is computer based and, among other things, functions as a receiver for advertising information transmitted from controller 520. As such, a standard file transfer protocol (FTP) application on both the system control computer 544 and the computer housed within display assembly 540 permits a controller operator to manually or automatically send and receive files.

Of special consequence is a status file transmitted from a display assembly 540 to controller 520. The status file transmits critical status records of the display assembly. Such records may include battery status, memory test results, video files, available from video cameras aboard display assembly 540, inventory and motion detection results. Elements of each of these records are discussed in more detail hereafter.

Controller 520 comprises parts which are well known and in wide use in Internet applications. Control computer 544 performs as a system control computer which, for example, may employ a Windows Operating System. Server 542 serves as a database server system and may employ the Microsoft operating system Windows known as NT with SQL (Microsoft's database system0. Computer 544 communicates advertising and other control information through modem 546 to each selected display assembly 540 as indicated in FIG. 3.

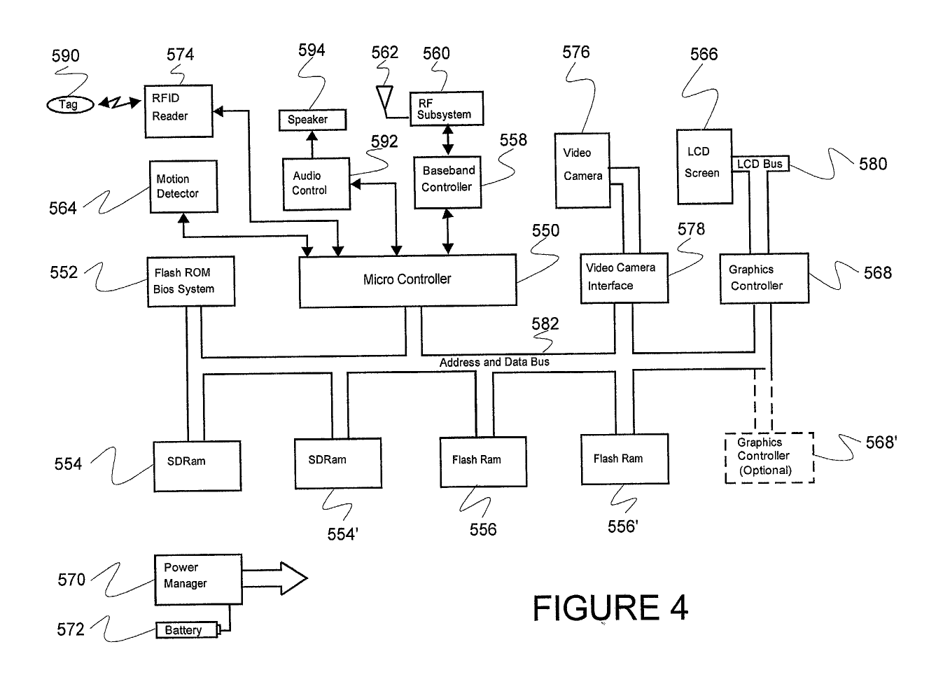

Each display assembly 540 comprises a number of functional subassemblies as seen in FIG. 4. Of these subassemblies, a number are basic to the overall instant invention, while others provide important specific features for display assembly 540.

Basic subassemblies of display assembly 540 comprise a micro controller 550; memory modules including a flash ROM bios system 552, SDRam modules 554 and 554′ and flash RAM modules 556 and 556′; a baseband controller 558 and associated RF subsystem 560 with antenna 562; a motion detector 564; at least one LCD screen 566 and associated graphics controller 568, as well as a power manager module 570 and an associated power source 572. As it is considered that, under normal conditions, display assembly 540 will likely be required to be used at a plurality of spaced selected sites within a store, at locations where electrical power may be readily available, power source 572 may and preferably is a battery.

Each display assembly 540 may also comprise augmenting subassemblies including a RFID reader 574 and a video camera 576 and associated video camera interface 578. See FIG. 4. Any display assembly 540 may operate as a stand-alone unit.

As shelf space is almost always a premium, retail products selected for depiction through illumination in display assembly 540 should be compact in all dimensions so far as possible. In addition, performance and power requirements should be critically evaluated before selecting components for subassemblies of display assembly 540.

To meet such requirements, micro controller 550 may be an Intel StrongARM SA-1110, which comprises a high-performance, low-power processor for portable wireless multi-media devices. The StrongARM SA-1110 is a 32-bit processor that incorporates Intel design and process technology. Memory control of the SA-1110 supports SDRAM, ROM, flash RAM and other types of memory. As an example, SDRAM modules 554 and 554′, flash ROM 552 and flash RAM modules 556 and 556′ are also interfaced with micro controller 550.

In the case of the StrongARM SA-1110, Windows CE is the operating system of choice, including applications for Windows media player version 7.1 or higher, pocket Internet explorer browser and FTP data transfer. Flash ROM 552 is programmed with Bios to start the CE operating system and to run selected startup application programs.

As is well known in the computer art, Windows CE operating system description is a modular real-time embedded operating system for small footprint and mobile 32-bit intelligent and connected devices. Windows CE combines Windows compatibility and advanced application services with support for multiple CPU architectures and built-in networking and communications options to deliver a rich, scalable, open foundation for building a wide variety of products. Windows CE powers consumer electronic devices, Web terminals, Internet access appliances, specialized industrial controllers, mobile data acquisition handheld and embedded communication devices. As a highly modular platform, Windows CE allows a developer to flexibly and reliably build new generations of small footprint and mobile 32-bit devices that integrate seamlessly with Windows and wireless applications.

Graphics controller 568 may be an MQ-1132 unit from MediaQ. The MQ-1132 is an integrated LCD (liquid crystal display) and peripheral controller with embedded memory for portable devices requiring long battery life and high performance. As such, graphics controller 568 readily interfaces with the Intel SA-1110 microprocessor of micro controller 550. In addition, software using the media player facilely accesses with the MQ-132 of graphics controller 568 to play video multimedia. Further the MQ-1132 is easily interfaced to many different sizes and formats of LCD screens. LCD screen 566 comprises an electronic billboard and may be Sharp LQ039Q2DS54 (a TFT-LCD module). Of course, other display modules with different sized displays may be used as the electronic billboard within the scope of the present invention to provide a variety of advertising sizes and resolutions.

As well, more than one LCD display may be used in any display assembly 540. As a point of fact, it is more likely that two screens will commonly be used so that advertising may be viewed along two opposing directions of an aisle. For such a purpose, a second LCD screen may be connected through an LCD bus 580 (the second screen is not seen in FIG. 4). If a capability of having each screen display different information is desired, a second optional graphics controller 568′ may be employed as seen in FIG. 4. Note that all communications between memory and video camera interface 578 and graphics controllers 568 and 568′ are made via an address and data bus 582. Such bus architecture is currently widely used and standard for the Intel SA-110 microprocessor.

It can be very important to restrict power usage to times when viewing of display assembly 540 is likely. For this reason, at least one motion detector 564 is directed for “down aisle” monitoring from display assembly 540. As an example, when no shopper is within 30 feet of display assembly 540, as sensed by detector 564, power to LCD screen 566 and video camera 576 is removed. Upon detection of motion by detector 564, a signal to microcontroller 550 returns power to affected subassemblies and normal advertising resumes.

Within the scope of the instant invention, motion may be detected via many methods, including those which employ photodetectors, ultrasound devices and video cameras. The method selected may employ a passive infrared detector, which provides a low cost detection system to constantly monitor for motion along an aisle. For this purpose, an Ademco Sensor Company 998PI preferably is interfaced to the StrongARM SA-1110.

While power may be acquired from a wall plug or the like, such are not typically available at all shelves in a retail store. Therefore, the source of power of choice is a battery, such as battery 572. Using one or more batteries, makes monitoring of remaining power stored in the battery desirable. Shutting off power to unessential subassemblies during periods of non-use is also desirable. For this purpose motion detector 564, power manager 570 and microcontroller 550 may be provided to manage and conserve battery power.

For each display assembly 540 to operate and provide changed and variable advertising and other displays in a hands free mode, control and data transmission must originate from a remote site (i.e. remote from controller 520). It is preferred that communications between controller 520 and display assembly 540 be wireless, to preclude a need for especially providing wired electrical power to display assembly 540, but hard wiring may be used. To provide a wireless communication link from display assembly 540, a Xircom Eagle II self-contained Global System for Mobile (GSM) communications radio may be used. This system is preferred because it supports worldwide coverage and interfaces directly to the StrongArm processor through a standard AT command set.

Having direct communications with a controller 520, display assembly 540, fitted with an RFID reader or other product tag reader, provides a unique and valuable service for product merchandising. Should a manufacturer or retail marketer elect to tag each product item displayed for sale on a shelf from which tag communications can be detected by such a reader, inventory movement can be continuously monitored without human intervention by the display assembly 540 and automatically reported to controller 520.

For this purpose, a UHF OEM Reader RFID system from Intermec Technologies Corporation may be used to monitor product inventory. Critical features of the Intermec product are a seven meter read range and an anticollision protocol which permits reading of up to forty tags per second, regardless of the number of tags in the read range. Intermec Technologies Corporation also supplies various kinds of RFID tags, which may comprise tag 590 as seen in FIG. 4. It should be noted that an anticollision protocol or equivalent may be important when monitoring changes in inventory as products are removed from or placed upon a retail shelf.

It may be desirable to monitor customer traffic along the aisle where a particular display assembly 540 is disposed. To this end, a video camera 576 (see FIG. 4) may be added to a display assembly 540 system. For this purpose, a single chip CMOS color digital video camera subassembly from OmniVision, model OV7620 may be used. The OV7620 subassembly provides several different digital formats which can be interfaced (e.g. at interface 578) with the StrongArm processor and converted to compressed format to save memory and communications upload time. The OV7620 may be fitted with a C3188A color camera module and interface 518 may use an OV511, USB (universal serial bus) controller chip which is compatible with the StrongArm processor USB port and CE Windows system using standard USB software modules. Periodic uploading and downloading of video information may be a part of the operation of display assembly 540. For some applications, a second video camera 576 may be employed to provide concurrent two-directional video processing, both up and down an aisle.

Alternatively, an A3 (Z4520) MPEG-4 Audio/Video Codec video interface from Emblaze Research may be used as interface 578 to gather video data. The A3 (Z4520) MPEG-4 camera is targeted for mobile video applications. It is a full duplex Audio/Video codec assembled for a large variety of applications including audio and video streaming, video capture from a CMOS sensor video camera, digital still image capture and video/audio player. Such an interface may be used to encode video and make the video available in a compressed format for live or delayed display or for sending to a master computer database which is disposed at controller 520.

Video feedback may be provided over LCD screen 566 (see FIG. 4) and over a second LCD screen juxtaposed LCD screen 566 and facing an opposite direction down the adjoining aisle. The second LCD screen is not seen in FIG. 4.

Audio feedback is provided via a standard audio control circuit 592 and associated speaker 594 as seen in FIG. 4. Speaker 594 may be used for audio portions of video presentations and for exclusively sound presentations which are a part of other advertising formats.

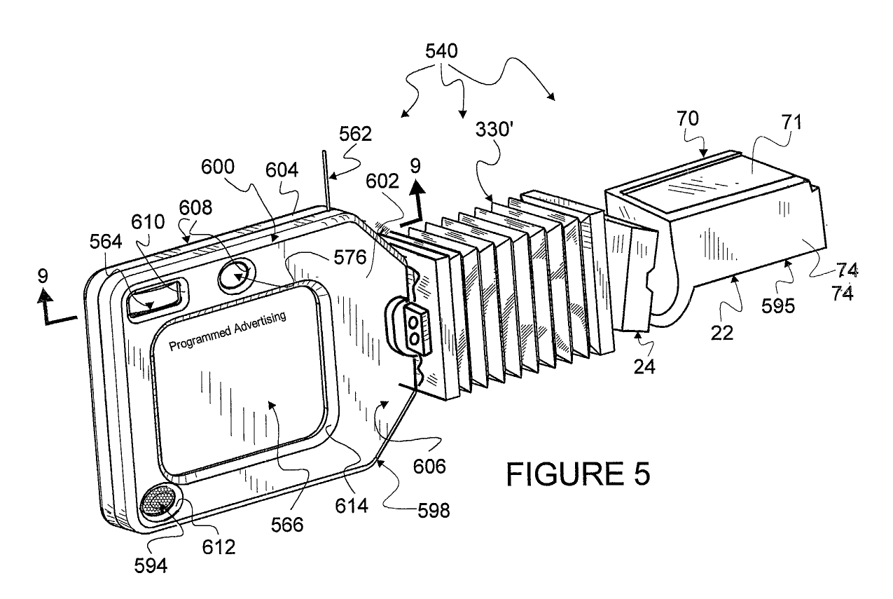

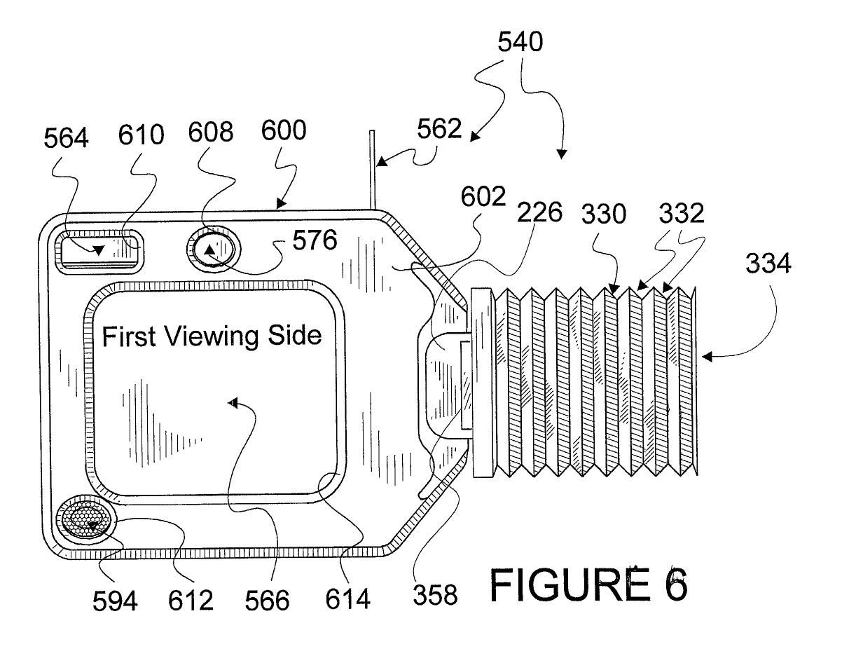

Reference is now made to FIGS. 5 and 6 wherein an exemplary model of one display assembly 540 is shown. As best seen in FIG. 5, display assembly 540 comprises a mounting member 595 by which display assembly 540 is securely although releasibly clamped to a shelf. Proximal to member 595 is a boot 330′ which, like boot 330 of FIG. 1, covers and protects a subassembly which pivotably and deflectibly connects a display portion 598 to member 595.

The subassembly within the boot 330′ and boot 330′ may be identical or similar in form and function to mounting members 22 and 24, hangar members 26A and 26B and boot 330 of display assembly 20 seen in FIGS. 1 and 2 as explained above. Thus, display portion 598 may be affixed to a shelf in the manner of display assembly 20.

However, the display portion 598 of display assembly 540 is in some respects significantly different from the display portion of Assembly 20. As explained above, display assembly 540 has a programmable electronic display or billboard and communication electronics providing opportunity for remotely generating and controlling advertising displays at the shelf. In FIG. 5, display assembly 540 is seen to have an assembled frame 600 which comprises a proximal frame component 602 and a distal frame component 604. Proximal frame component 602, as seen in FIGS. 5 and 6, is a part of a first side 606. A second side juxtaposed side 606 is disclosed in detail hereafter.

Proximal frame component 602 is further seen to comprise an elevated cental orifice 608, an adjacent elevated distally disposed orifice 610, an inferiorly, a lower distally disposed orifice 612 and an advertising window or opening. Frames 602 and 604 may be made from synthetic resinous material, such as ABS or other material used for laptop computer cases and the like. Processes for assembling such frames into a secure package are well known in computer art, such as in manufacture of laptop computers, and, therefore, will not be dealt with further herein.

Orifice 608 provides a visual pathway for video camera 576 (see FIG. 4). In similar fashion, orifice 610 provides a portal for motion detector 564 and orifice 612 is an outlet for speaker 594. Opening 614 provides a large rectangularly shaped opening for LCD advertising screen 566. In this manner, a full complement of consumer communicating components are provided on one side of display portion 598.

In addition, antenna 562 is seen extending in a vertical direction above internal frame component 606. As earlier disclosed, controller 520 communicates control and advertising displays via wireless communications through antenna 562 to display assembly 540 for illuminated presentation at opening 614.

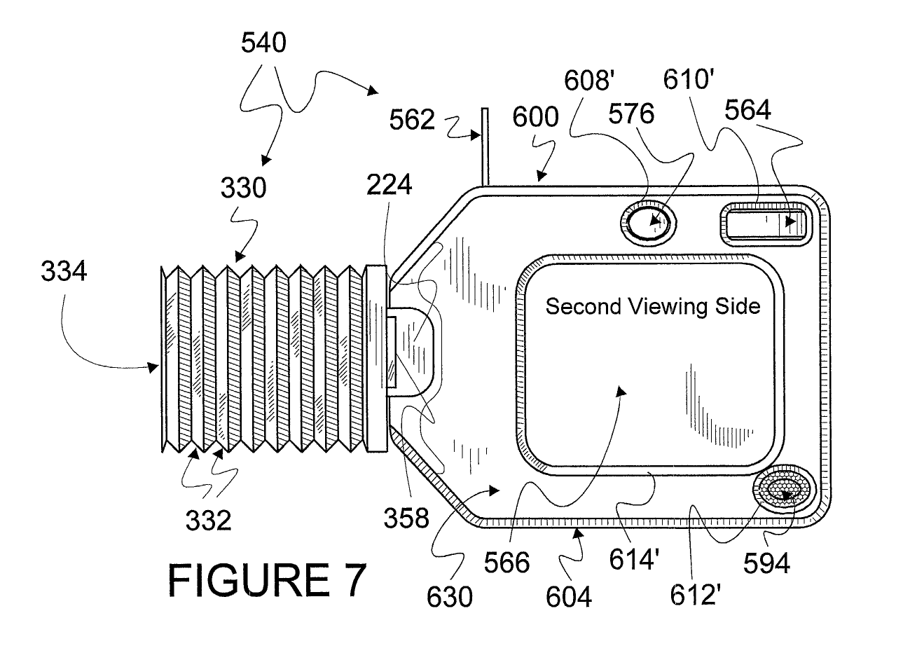

As it is preferred that display assembly 540 be effective as an advertising display when viewed from both directions along a retail shopping aisle, some parts may be replicated on a side 630. As seen in FIG. 7, similar to side 606, side 630 is seen to comprise proximal frame component 604 which has an orifice 608′, an orifice 610′, an orifice 612′ and an advertising opening 614′.

Orifice 608′ provides a visual pathway for a second video camera, which is generally referenced by 576 as it is the same type of component used on side 606. In similar fashion, orifice 610′ provides a portal for a second motion detector 564 and orifice 612 is an outlet for speaker 594. Opening 614′ provides a large rectangularly shaped opening for a second advertising LCD screen 566′. In this manner a full complement of consumer communicating components are also provided on side 630 of display portion 598.

Having such a full complement provides significant advantages, such as a second detector permits detection approaching consumer traffic from only one direction. Thus, only one LCD, such as LCD screen 566 of orifice 614′, need be activated at one time to conserve power. Also, separate and different messages may be simultaneously displayed on opposite sides of the same display assembly at any given time to take advantage of multiple marketing opportunities. Two video cameras, when used, provide views from the associated isle in both directions. A second speaker 594 not only permits a second audio source, but also minimizes auditory listener dead spots.

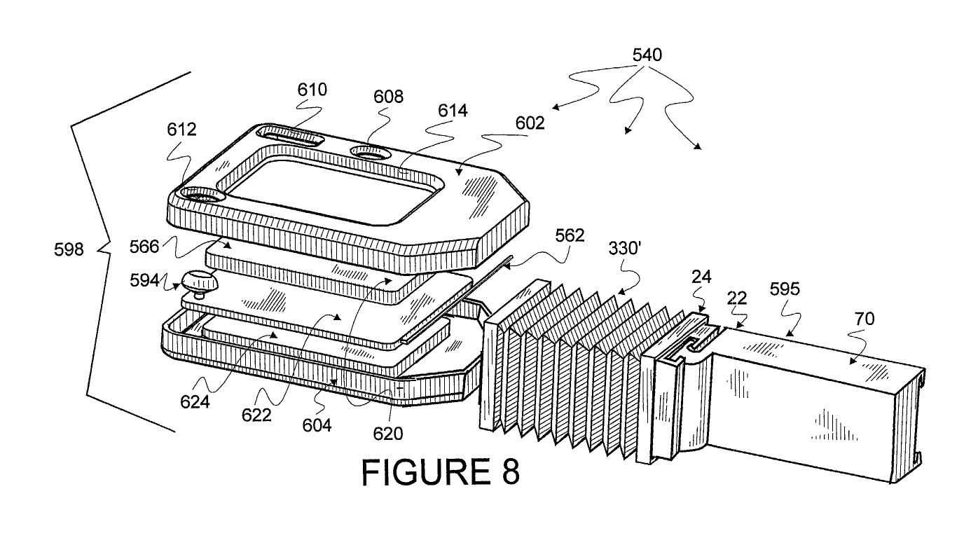

Display portion 598 of display assembly 540 is exploded in FIG. 8 so the sandwiched packaging utilized may be better visualized. Display portion 598 comprises proximal frame component 602 and distal frame component 604. Disposed between frame components 602 and 604 are a first LCD subassembly 620, a processor subassembly 622 and a second LCD subassembly 624. Subassemblies 620, 622 and 624 are seen in box format for clarity of presentation. One skilled in contemporary computer art well understands standard assembly of connectors, electronic chips and other electronic parts which are used in such subassemblies.

LCD subassembly 620 has liquid crystal display screen 566 which is disposed to be viewed through advertising window 614. Speaker 594 is affixed to processor subassembly 622 for ease of assembly and maintenance. In similar fashion, video camera 576 and motion detector 564 are likewise affixed to processor subassembly 622, but not seen in FIG. 8. In addition to video camera 576, motion detector 564 and speaker 594, RF subsystem 560 and associated baseband controller 558, micro controller 550, audio control 592 and video camera interface 578, graphics controller 568 (and graphics controller 568′, when used), and other memory systems, such as flash ROM bios system 552, SDRAM 554 and 554′ and flash RAM 556 and 556′ are disposed upon processor subassembly 622. Processor subassembly 622 may be a printed circuit board, while LCD subassemblies 620 and 624 are available as commercial electronic packages.

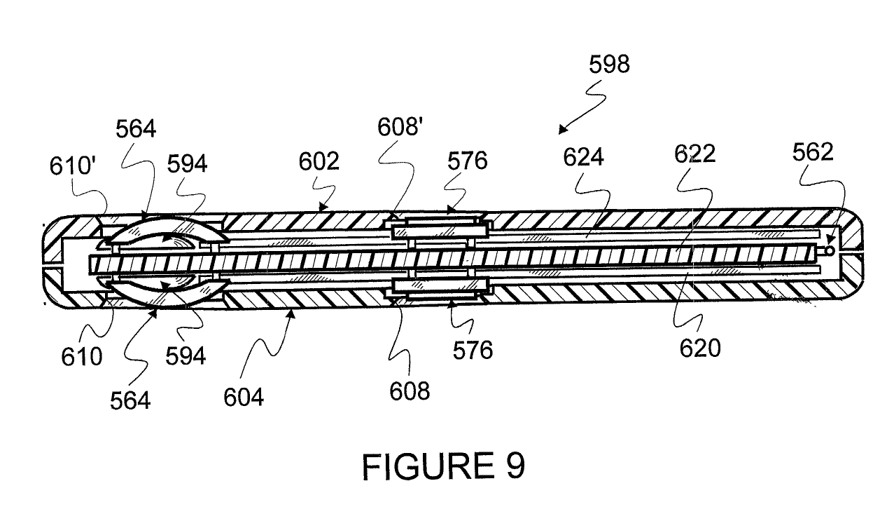

Similar to LCD subassembly 620, LCD subassembly 624 has LCD second screen 566 affixed to an unseen underside, which is better seen in FIG. 7. Note that antenna 562 is directly affixed to processor subassembly 622. A cross sectional top view of display portion 598 (FIG. 9) shows relative positions of video camera 576, motion detector 564 and speaker 594 as mounted upon processor subassembly 622 and visible through related orifices, windows, openings or ports.

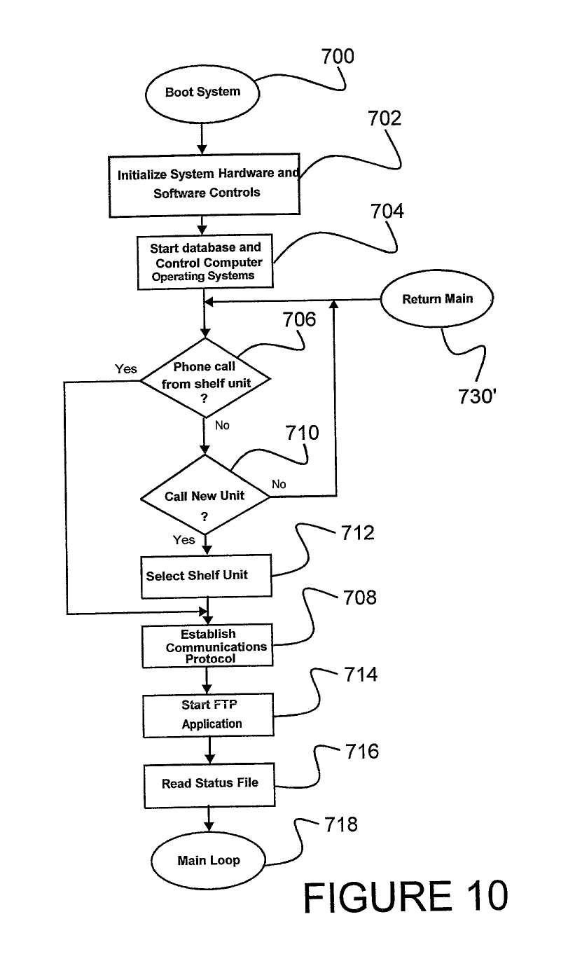

Reference is now made to FIGS. 10-21 wherein flow diagrams of controller 520 and display assembly 540 are disclosed. In FIGS. 10-21, ellipses (ovals) are used to designate continuations from one flow diagram to another. Diamonds are used to indicate binary decisions, and rectangles are used to designate functional programs.

A main controller 520 is generally anticipated to be remotely disposed relative to each particular display assembly 540. Information which is to be advertized or otherwise displayed on a display assembly 540 is first organized and stored in the controlling computer system. Such information generally includes graphics files, video files, audio files and HTML/XML files. The HTML/XML files are programs which are downloaded to a display assembly 540. Such programs control operation, sequence, timing and other functional aspects of a receiving display assembly 540.

Thus, standard HTML/XML programs are facilely used to control an Internet Browser application which runs on the receiving display assembly 540. As such, graphics files, video files, audio files and other written information is readily controlled and sequenced to produce effective advertising media which is ultimately displayed on the receiving display assembly 540. As one skilled in Internet programming well understands, use of browser based programs, common in web-based programming, is an effective way of programming.

Files downloaded/uploaded to/from, respectively, a display assembly 540 via a telephone (or alternatively as cell phone) link, are preferably transferred using a standard FTP (file transfer protocol) application on both a controller 520 and each linked display assembly 540. These transfers may be performed either manually under control of an operator or automatically. Such transferred files include status information (a status file) from a sending display assembly 540. Such status information may include battery status, memory test results, video files created at the display assembly 540 via video camera 576, motion detection/power save mode control and inventory data.

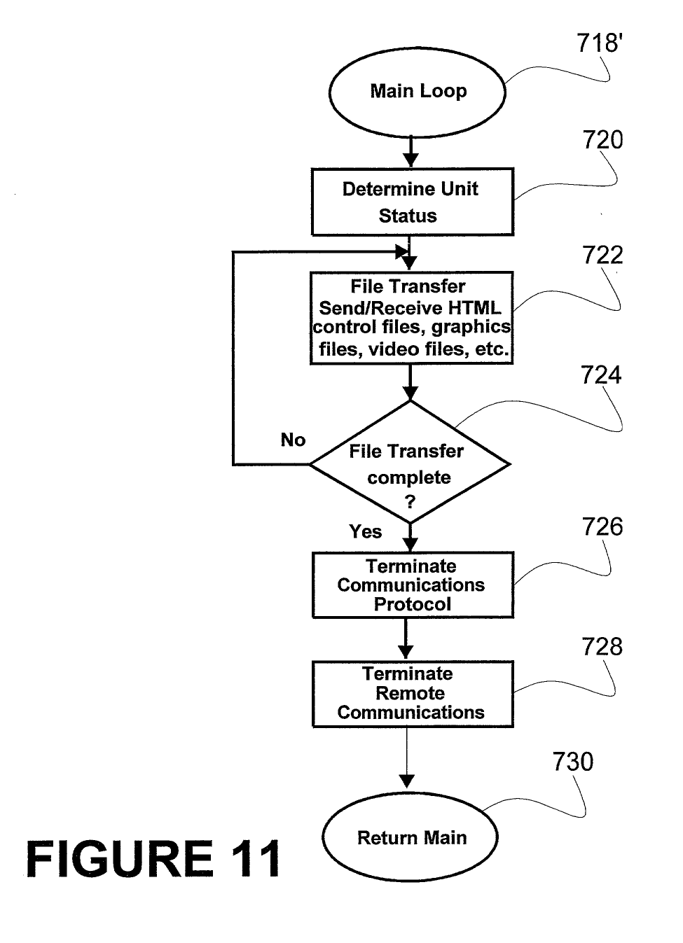

As seen in FIGS. 10 and 11, controller 520 serves each display assembly 540 with commercially available drivers. The drivers are programmed to provide advertising and other control programs which control and update operation of each individual display assembly 540. Operation of controller 520 is initiated by a standard booting process as identified by entry oval 700. As indicated by finction block 702, hardware and software controls are initialized. Databases and controller 540 operating systems are initiated per block 704.

Following initialization, a determination is made (decision 706) concerning whether or not a call has been received from a display assembly 540. If so, program flow continues to a block 708; otherwise, a queue is probed to determine whether or not a communication has been scheduled for any assembly 540 at decision 710. If not, program flow returns to decision 706. If so, program flow continues to block 712 wherein the selected display assembly 540 is addressed.

Whether data is flowing to or from controller 520, a communications protocol is established via block 708. Function of block 714 begins a file transfer protocol (FTP) and, as standard practice, a status file of the selected display assembly 540 is read (block 716). Oval 718 is a link to oval 718′ of FIG. 11.

After reading the status file of the selected display assembly 540, status is reviewed, as function 720, for previously mentioned parameters, e.g. battery status, inventory change, etc. Upon completion of status review, any files scheduled for transfer (either to be sent or received) are transmitted via function block 722. Such files include, but are not limited to, HTML control files, graphics files and video files. At the end of transfer of each file, a decision 724 either directs program flow to block 722 to send another file or, if all transfers to or from the selected display assembly are complete, terminates communications at function block 726. Upon termination of remote communications (block 728), program flow continues through linking oval 730 back to linking oval 730′ of FIG. 10.

A typical multimedia advertising segment is normally designed with video, audio, graphics, written and other forms of digitized communications, each associated file is stored and a browser based program is generated which controls all functions, sequencing and timing of the segment. Each commercial type of video is digitized and stored in compressed video format, such as MPEG. Digitized audio files are also recorded and stored to correlate information between a video and an audio file or between audio and graphics or other displayable indicia. Another example of stored data is a graphics file of a product picture. All such information is generally first stored within controller 520 and later transmitted to at least one preselected display assembly 540.

To transfer a file, a display assembly 540 is contacted via phone line (cellular) communications. An FTP communications protocol is invoked on both controller 520 and the selected display assembly 540 to facilitate file transfer. Each file transferred to a display assembly 540 is generally stored for later use in the display assembly. For such, each display assembly 540 has a browser based program named “altmain.html” downloaded from controller 520. The purpose of this file is to prevent interference with existing operation of the selected display assembly while new information is being downloaded. As each file transfer is complete, display assembly 540 renames “altmain.html” to “main.html” and begins a new advertising control sequence. Note that all files for new advertising must be downloaded or already present in display assembly 540 memory before being used by display assembly 540.

As a part of file transfer protocol, while connected, a selected display assembly 540 may also upload files to controller 520. As an example, video files acquired through video camera 576 may be sent to controller 520. While connected to a selected display assembly 540, controller 520 may elect to command the selected display assembly 540 to transmit a real time video as a streaming media or to display the video in real time on LCD screens, generally referenced as 566. Note that information shown on an LCD screen 566 is not limited to advertising, but may also be weather data, traffic conditions or other information which may be eye catching.

Examples of information which may be presented at a display assembly 540 include:

Program and preview messages, advertising information;

Program video information;

A promotional campaign;

General information, such as news clips, weather, etc.;

Product descriptions, including recipes;

Audio;

Streaming media, such as video camera 576 output;

Null operation (no picture) when no movement present;

Inventory status.

Examples of remote control via controller 520 over a selected display assembly 540 are:

Initiate a display assembly 540 self test of such parts as RAM (parts 554, 554′, 556 and 556′), graphics controller 568 (and 568′), microcontroller 550, battery 572, power manager 570 and a transmittal of display assembly 540 status file;

Display a predetermined stored commercial video;

Display a selected advertisement;

Display real time video images from camera 576;

Transmit video images from display assembly 540 to controller 520;

Store current video images for later use;

Control sequence of advertising display;

Sleep circuit delays associated with motion detector 564 operation;

Inventory and product tracking activity by display assembly 540.

Examples of data collected at a display assembly 540 includes:

a Video/audio recordings from video camera 576;

Motion detection (from detector 564);

Inventory change data (from RFID reader and associated tag 590);

Battery status.

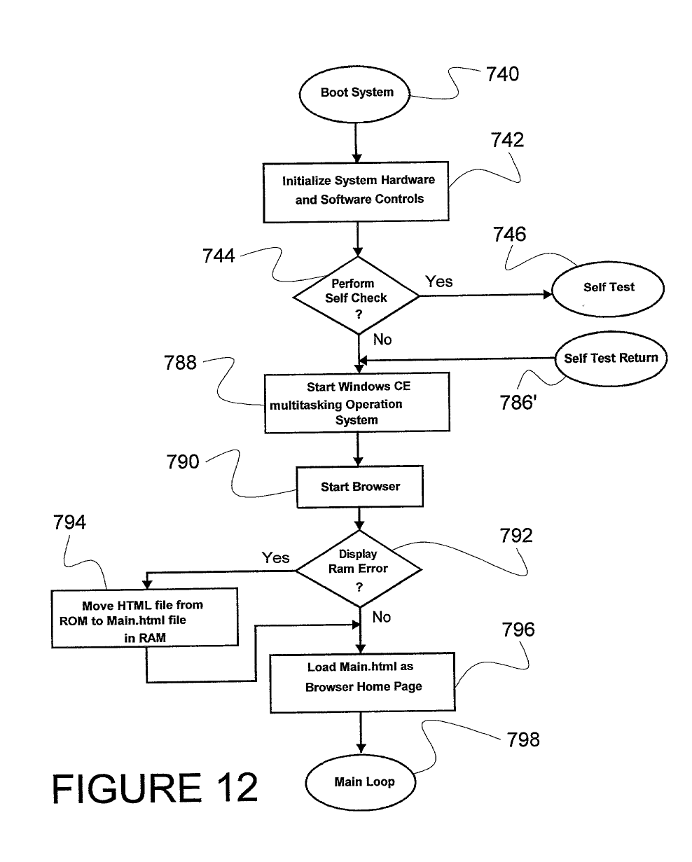

Reference is now made to FIGS. 12-21 wherein program flow for a display assembly 540 is seen. Operation of display assembly 540 is initiated by a standard booting process as identified by entry oval 740. As indicated by function block 742, hardware and software controls are initialized.

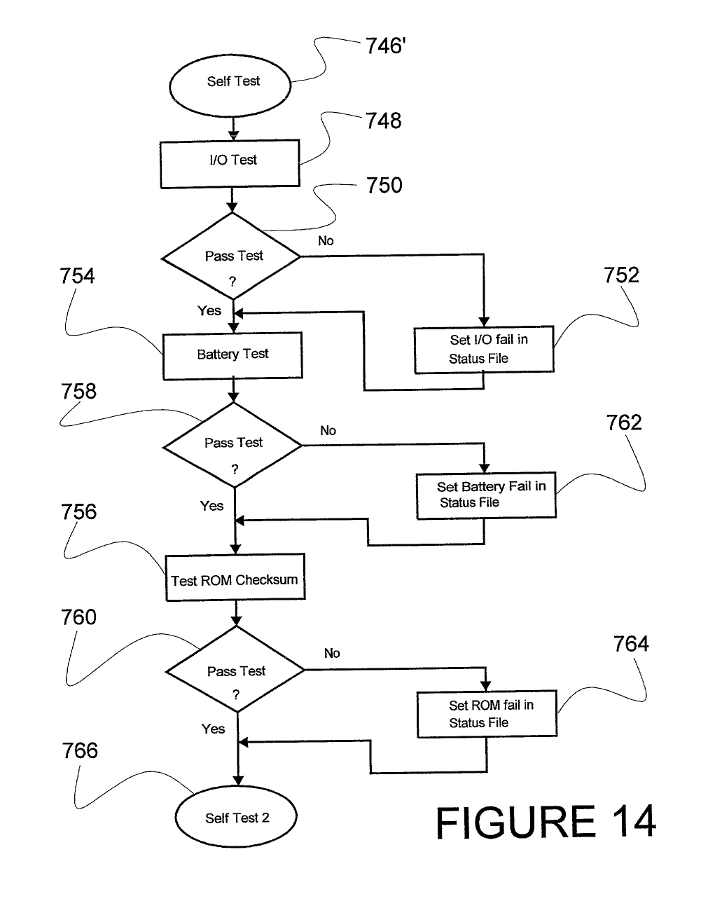

If a self check decision is made (decision 744) a self test program is entered via oval 746 to oval 746′, as seen in FIG. 14. Entry into self test begins with a test (function 748) of display assembly 540 input and output parts. Such tests are well known and standard for existing computer systems. Should function 748 yield a detected failure (decision 750), an indication of any such failure is recorded as a flag in the display assembly 540 status file (function 752).

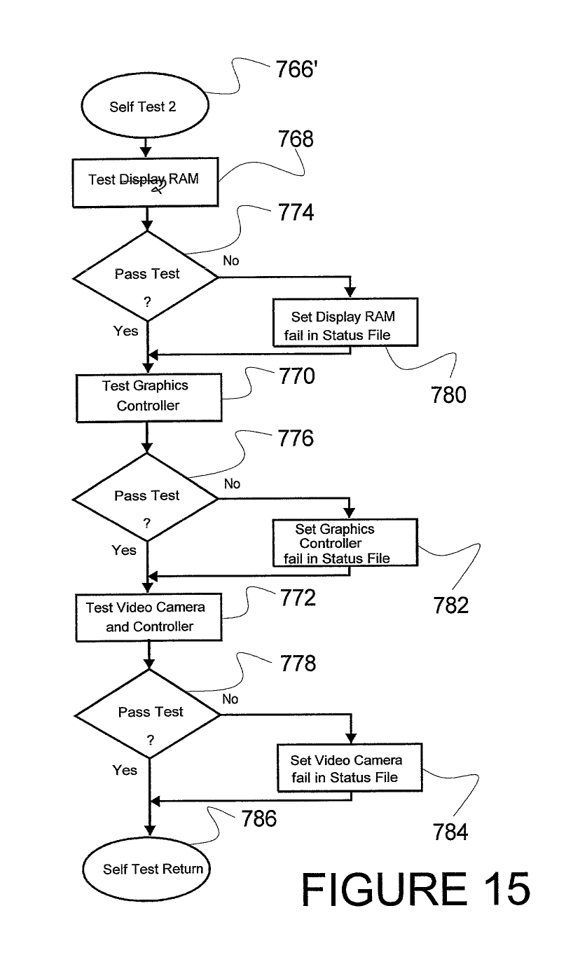

In similar fashion, testing of battery 572 and ROM 552 (via checksum) are performed by functions 754 and 756, respectively. Decisions of pass or fail are made at decisions 758 and 760, respectively and the status file, when appropriate, is updated by functions 762 and 764, respectively. Upon completion of ROM 552 test, a pathway through oval 766 to oval 766′ (see FIG. 15) continues self testing of display assembly 540.

Tests of RAM (parts 554, 554′, 556 and 556′) via function 768, of graphics controller 568 via function 770 and video camera 576 and controller 578 via function 772 are successively made. At each test, respective decisions 774, 776 and 778 result in appropriate flags being set in the status file by respective functions 780, 782 and 784. Upon completion of the tests of FIG. 15, a pathway through oval 786 to oval 786′ returns program flow to FIG. 12.

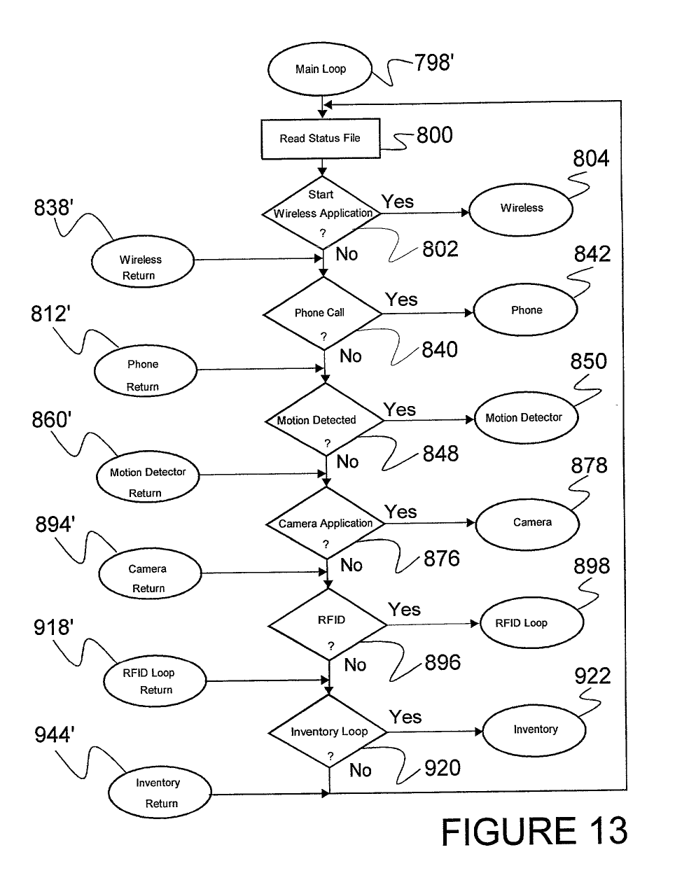

Following the selftest sequence, Windows CE Operating System is entered at function 788. The aforementioned browser is begun by function 790. If a display RAM error is detected (decision 792), an HTML file, stored in ROM, is transferred to “main.html” in RAM (function 794). In any event, “main.html” is loaded as browser home page (function 796). Once function 796 is completed, the main program loop of display assembly 540 is entered via oval 798 to oval 798′ (see FIG. 13).

Stored in the status file of each display assembly 540 is a flag which indicates activity requirements in the areas of wireless/phone operation, motion detection, video camera operation, RFID use and inventorying. To establish bases for operation within the main loop, the status file is read for processing in function 800.

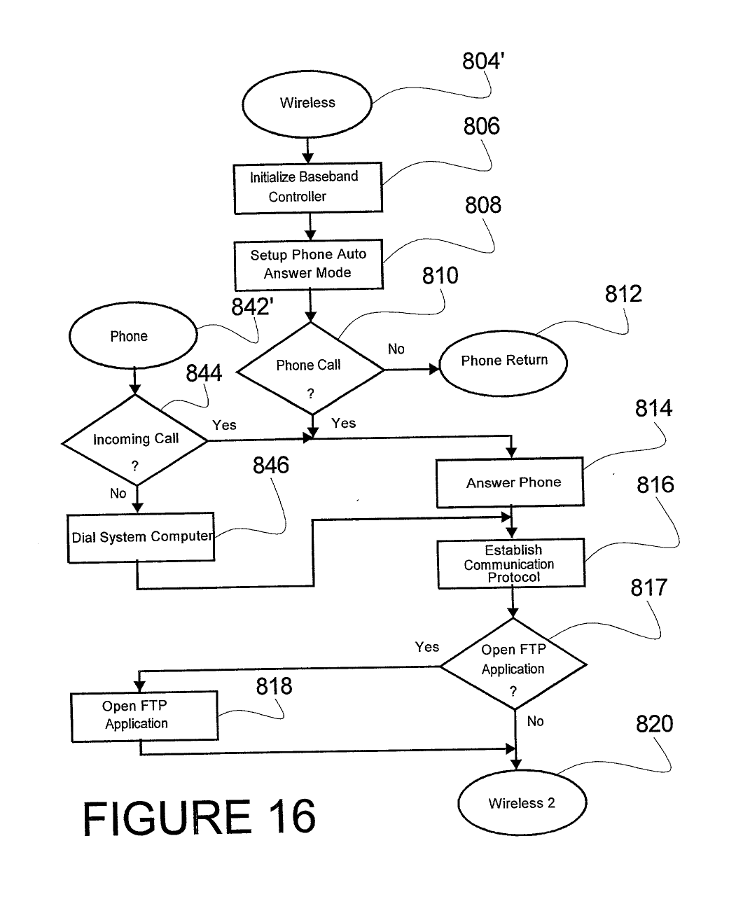

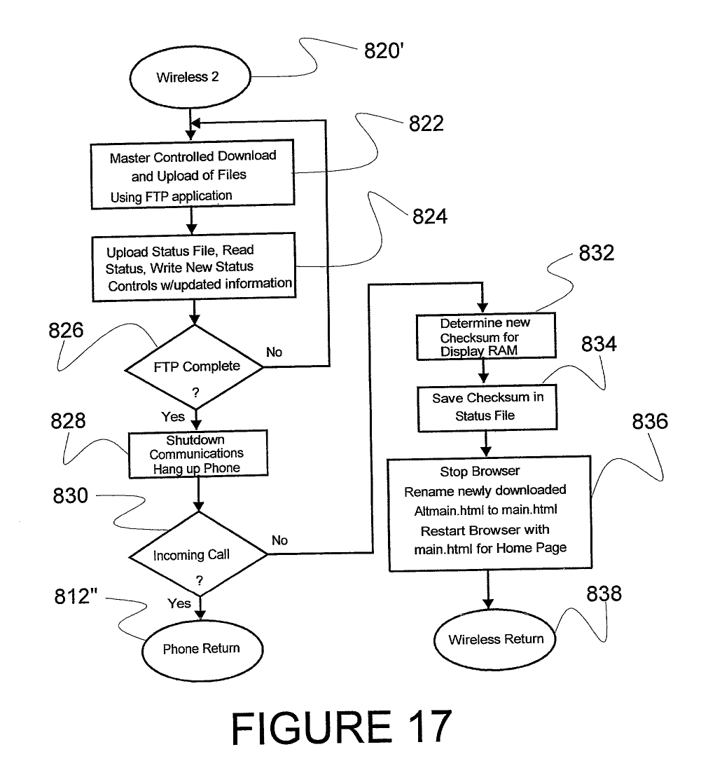

If a start wireless application flag is set, decision 802 directs program flow through oval 804 to oval 804′ (see FIG. 16). For wireless operation, the first step (function 806) involves initializing baseband controller 558, a process which is well known in computer communications art. Function 808 sets phone communication to auto-answer mode. Decision 810 determines whether or not a phone call is on line. If not, oval 812 returns program flow to phone return oval 812′ (see FIG. 13). If yes, function 814 answers the call. Communication protocol is satisfied by function 816. If there is need for a file transfer protocol (decision 818), decision 817 steers program to function 818 which opens a FTP application routine and program flow continues through oval 820 to oval 820′ (see FIG. 17). If there is no need for file transfer, program flow proceeds from decision 817 through oval 820 to oval 820′ (see FIG. 17).

As directed by controller 520, any specified files are downloaded or uploaded using FTP (function 822). The status file is transmitted, via function 824, to controller 520 with any new status information. If the FTP operation needs repeating (decision 826), program flow returns to function 822. Otherwise, program flow proceeds to function 828 which shuts down communications and hangs-up the phone. Decision 830 determines whether or not the call was incoming. If so, a pathway through oval 812″ returns through oval 812′ (see FIG. 13).

Otherwise, function 832 determines a new checksum of RAM used for LCD screen 566 display and the new checksum is stored in the status file by function 834. At this point, function 836 stops the display 540 browser, renames downloaded “altmain.html” to “main.html” and then restarts the browser with “main.html” as home page. Upon completion of function 836, oval 838 returns program flow through oval 838′ of FIG. 13.

Note, in FIG. 13 that oval 838′ and a “no” result of decision 802 directs program flow to decision 840 which, when affirmatively determined by a phone request flag in the status file, directs flow outward through oval 842 to 842′ of FIG. 16. If the phone request flag (determined by decision 844) is for an incoming call, program flow continues to function 814 as disclosed earlier in the text. Otherwise, function 846 dials controller 520 and, upon connection, program flow continues to function 816, also earlier referenced.

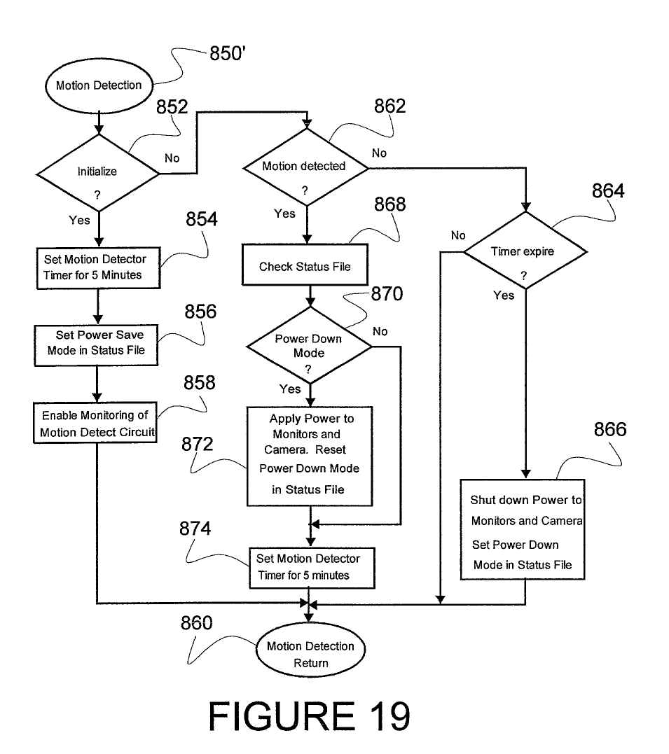

From oval 812′ and decision 840, program flow continues to decision 848 where at which time a motion detection request flag in the status file directs flow through oval 850 to oval 850′ of FIG. 19. If a flag in the status file indicates motion detection is to be activated, a determination by decision 852 directs program flow to function 854. Function 854 sets a motion detector timer in microcontroller 550 for five minutes (or other time as determined by controller 520). Function 856 sets display assembly 520 into a “sleep” (power save) mode. Function 858 enables monitoring of motion detector 564 and program flow returns to the main loop via oval 860 to oval 860′ (see FIG. 13).

If, at decision 852, motion detection operation is already initialized, decision 862 determines whether or not motion has been detected. If not decision 864, determines whether or not the previously set motion detector timer in microcontroller 550 has timed out. If not, program flow is to oval 860 and to oval 860′ (see FIG. 13). If the motion detector timer has timed out, the earlier described sleep mode is instigated by powering down the video camera 576, the active LCD screen 566 and other power draining circuits which may be deactivated in a sleep mode (function 866). A power down or sleep flag is set in the status file. Note that display assembly 540 may have duplicate motion detectors, LCD screens and video cameras disposed on opposite sides of the display assembly 540. In such a case, these parts may be independently controlled and set into power down or sleep mode. Upon completion of function 866 program flow is also through oval 860.

If motion is detected, function 868 acquires the status file. If a flag in the status file (decision 870) indicates a mode of display assembly 540 to be power down or sleep, function 872 reactivates those parts of display assembly 540 which are associated with the motion detector 564 sensing activity, providing power to at least one LCD screen and other parts powered down as part of the sleep mode. Once function 872 is complete, program flow is steered through function 874 where the motion detector timer is reset to five minutes and then exits through oval 860 to oval 860′ of FIG. 13. If that portion of display assembly 540 which is associated with the motion detected is not powered down or in a sleep mode, decision 870 directs program flow to function 874.

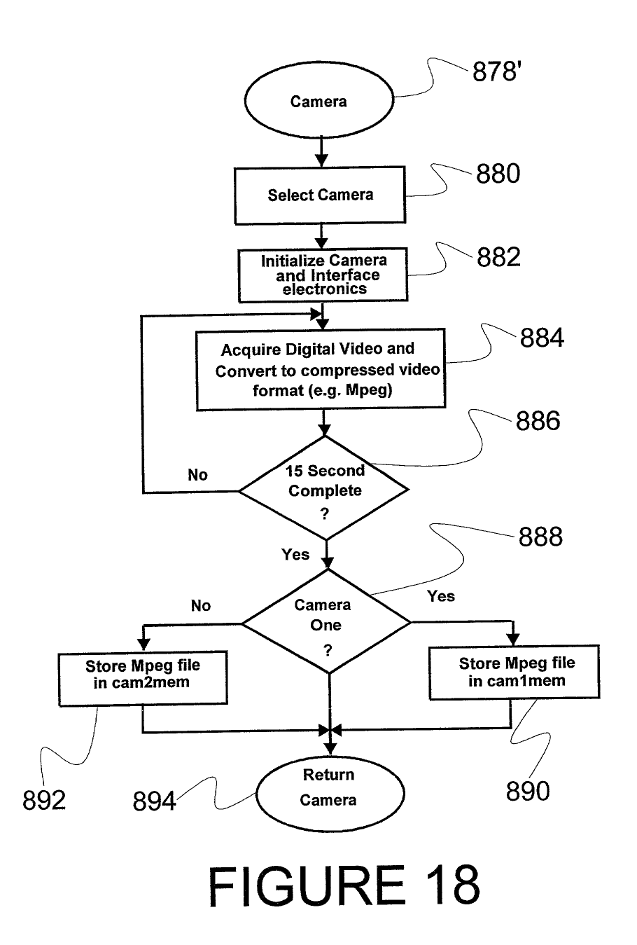

If a flag in the status file indicates a predetermined video camera 576 application activation, decision 876 steers program flow through oval 878 to oval 878′ of FIG. 18. Function 880 selects video camera interface 578 and associated electronics of predetermined video camera 576. Function 882 initializes the selected interface 578 and associated electronics. Function 884 acquires a video string and converts the string to compressed video format (e.g. MPEG). Decision 886 forms a timer for a fifteen second video segment made up of a sequence of the video strings.

Upon completion of the fifteen second video segment, decision 888 references the status file to determine which (if two) video cameras was being used. If a video segment was taken from a first video camera 576, the resulting compressed video file is stored in a first video file (e.g cam1mem) via function 890. If the video segment was taken from a second video camera 576, the resulting compressed video file is stored in a second video file (e.g. cam2mem) via function 892. In either event, program flow is returned via oval 894 through 894′ to the main loop seen in FIG. 13.

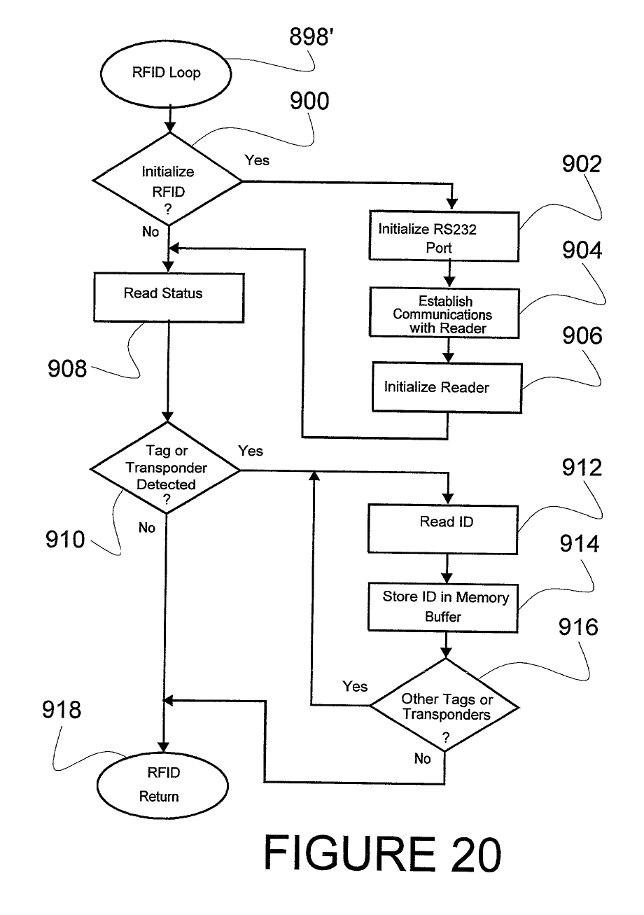

A flag set to read one or more tags 590 for the purpose of determining inventory changes of a particular product on a shelf in the vicinity of display assembly 540 causes decision 896 to direct program flow through oval 898 to oval 898′ as seen in FIG. 20. At entry, decision 900 determines whether or not an initialization flag is set in the status file. If not, function 902 initializes an associated RS232 port by which RFID reader 574 communicates with microcontroller 550. Thereby communications are established with reader 574 via function 904 and reader 574 is initialized by function 906. Once reader 574 is initialized, program flow connects with program flow from decision 900 to enter status read function 908. To read status of one or more tags or transponders 590 a RFID signal is generated and a coded tag 590 response is received and decoded. If, decision 910, at least one tag or transponder 590 is detected, program flow proceeds to identify one of the responding tags or transponders 590. Function decodes the ID of a detected and decoded tag or transponder 590 (function 912) and records that ID as an item in an inventory memory buffer as a part of recorded list. As there will typically be a plurality of individual tags or transponders on separate products in the scanned group of products, decision 916 determines whether or not all responding tags or transponders of the particular product interrogated have been identified. If not, program flow cycles back to function 912 to form a RFID or product count loop. If there are no unread tags or transponders 590 program flow is through oval 918 to oval 918′ on FIG. 13.

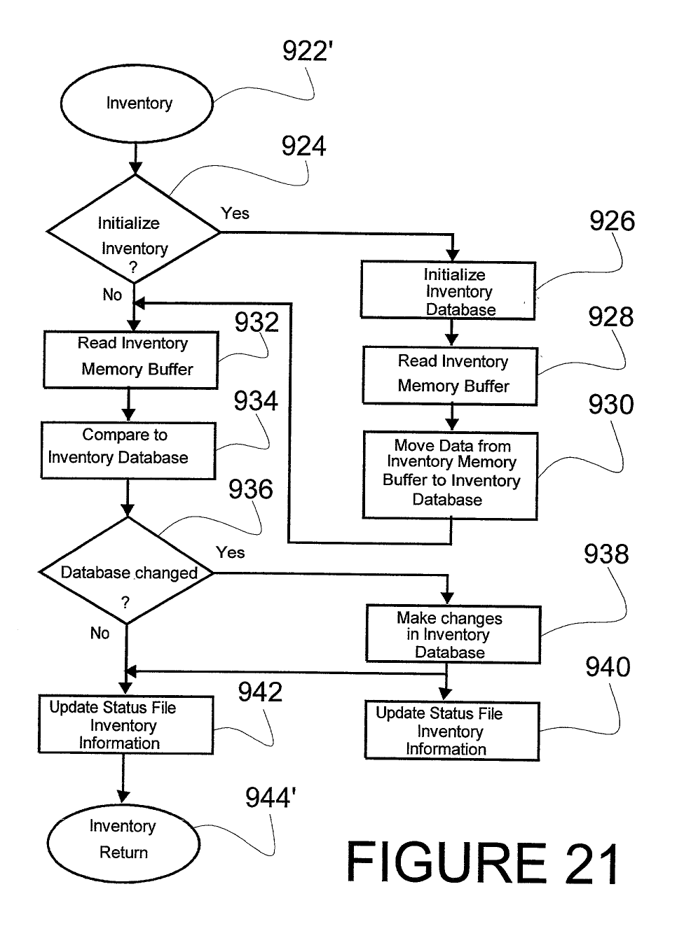

Once the RFID loop is complete and when the status file flag signals a requirement to take a shelf-borne inventory, decision 920 steers program flow through oval 922 to oval 922′ seen in FIG. 21. Upon entry to oval 922′, an inventory loop begins. The status file is accessed to determine whether or not to initialize an inventory database file. Decision 924 directs program flow to function 926 if the inventory database is to be initialized (yes leg). Function 926 nulls the inventory database file and function 928 accesses the inventory memory buffer. Subsequent function 930 moves data from the inventory memory buffer into the inventory database to establish a baseline inventory.

Program flow from function 930 joins program flow from the “no” leg of decision 924 to function 932. Function 932 reads the inventory memory buffer and function 934 compares data stored therein with data stored in the inventory database. Decision 936 directs program flow to function 938 when a change in inventory is calculated. Function 940 sets an appropriate flag in the status file to indicate a change in inventory. If there was no change in inventory, function 942 sets an appropriate flag in the status file to indicate a lack of change in inventory. Following functions 940 and 942 program flow is directed through oval 944 to 944′ of FIG. 13. Flow through oval 944′ and a “no” leg from decision 920 loop back to function 800 wherefrom the main loop recycles.

Generally, programming, as disclosed in FIGS. 10-21, for all of the parts seen in FIGS. 3 and 4, for example, may be performed by one who is skilled in the digital computer programming art. The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A point-of-purchase advertising system comprising:
at least one programmable, display assembly adapted to be securely connected to a self-service product display shelf such that an illuminable advertising portion of the display assembly extends into a shopping aisle adjacent the display shelf for visual observation by shoppers; and
a controller, remotely disposed relative to the assembly;
said assembly and controller, in combination, comprising a data link to thereby provide variable point-of-purchase illuminated advertising.

2. A system according to claim 1 wherein the display assembly further comprises a low-power computer comprising digital memory to store advertising displays, communications and control programs and data acquired by the computer; at least one graphics display; a power supply; and a shelf-mounting system whereby the display assembly is securely connected to the shelf, the power supply being carried by the display assembly connected to the shelf.

3. A system according to claim 2 wherein said power supply comprises a low voltage battery, the weight of which is not borne by the portion of the display assembly which extends into the aisle.

4. A system according to claim 3 wherein the battery is carried by a holder disposed under the shelf, which holder is connected to the shelf.

5. A system according to claim 2 wherein said display assembly further comprises a video camera whereby images from the aisle are captured and stored in the display assembly.

6. A system according to claim 2 wherein said display assembly further comprises a video camera whereby images from the aisle are captured and transmitted to the controller.

7. A system according to claim 2 wherein said display assembly further comprises a video camera whereby images from the aisle are presented in play back mode on the graphics display.

8. A system according to claim 2 wherein said display assembly further comprises a switchable sleep circuit which, when activated, substantially cuts off power to the display assembly and when deactivated resumes power to the display assembly.

9. A system according to claim 8 wherein said display assembly further comprises a motion detector which is disposed to sense movement along the aisle and which deactivates the sleep circuit when motion is detected along the aisle.

10. A system according to claim 8 wherein said display assembly comprises a pair of separately powered and controlled graphics illuminated displays which are visually observable in opposing directions along the aisle.

11. A system according to claim 10 wherein the switchable sleep circuit, when activated, selectively cuts off power to both graphics display assemblies.

12. A system according to claim 11 wherein said display assembly further comprises a pair of motion detectors which are generally in opposed alignment such that each detector is disposed to sense movement along the aisle in a direction opposite to the motion detection field of the other motion detector, each such detector selectively deactivating the sleep circuit for an associated graphics display when motion is detected along the aisle.

13. A system according to claim 11 wherein said display assembly further comprises a timer which times out to activate the previously deactivated sleep circuit.

14. A system according to claim 2 wherein said display assembly further comprises a product identification system whereby without human intervention a real-time inventory is taken of shelf resident products marked by remotely readable identifiers, such identifiers comprising at least one identifier selected from the group consisting of tags, transponders and other markers which are responsive to interrogating signals from the identification system.

15. A system according to claim 2 wherein said display assembly further comprises a modem and associated electronics which provide remote wireless, programmed, automatic communications with said controller.

16. A system according to claim 2 wherein said graphics display comprises a liquid crystal screen.

17. A system according to claim 2 wherein said display assembly further comprises two juxtaposed graphic displays oriented so that video images are seen from opposite directions along the aisle.

18. A system according to claim 1 wherein said at least one display assembly comprises a plurality of display assemblies.

19 A system according to claim 1 wherein the portion of display adapted to project into the aisle does so perpendicular to the aisle and is deflectable when struck by a person or object.

20. A remotely programmable, computer-controlled display assembly securely and transversely connected to a self-service product display shelf such that at least a portion of the display assembly projects for visual observation into an aisle adjacent to the display shelf, said display assembly comprising:
a digital processor comprising sufficient digital memory to store advertising displays, communications and control programs and data acquired from a remote source; at least one graphics display; a power supply; and a shelf-mounting system whereby the display assembly is securely connected to the shelf, the power supply comprising weight which is transferred directly to the shelf and not to the portion of the display projecting into the aisle.

21. A display assembly according to claim 20 wherein said power supply comprises at least one low voltage battery.

22. A display assembly according to claim 20 wherein said shelf-mounting display assembly comprises a receptacle for a battery supported directly by the shelf.

23. A display assembly according to claim 20 wherein said display assembly further comprises a video camera and microphone whereby images and sounds from the aisle are captured and stored in the display assembly.

24. A display assembly according to claim 20 further comprising a remotely disposed computer controller and wherein said display assembly further comprises a video camera whereby images from the aisle are captured and transmitted to the controller.

25. A display assembly according to claim 20 wherein said display assembly further comprises a video camera whereby images from the aisle are presented in real time on the graphics display.

26. A display assembly according to claim 20 wherein said display assembly further comprises a switchable sleep circuit which, when activated, cuts off substantially all power to the display assembly and when deactivated resumes power to the display.

27. A display assembly according to claim 26 wherein said display assembly further comprises a motion detector which is disposed to sense movement along the aisle and which deactivates the sleep circuit when motion is detected along the aisle.

28. A display assembly according to claim 20 wherein said display assembly comprises a pair of separately powered and controlled graphics displays which present illuminated visual advertising in both directions along the aisle.

29. A display assembly according to claim 28 wherein said assembly comprises a switchable sleep circuit, which, when activated, selectively cuts off power to both graphics display assemblies.

30. A display assembly according to claim 29 wherein said display assembly further comprises a pair of motion detectors which are in generally opposed alignment such that one detector is disposed to sense movement along the aisle in a direction opposite the other motion detector, each such detector selectively deactivating the sleep circuit for an associated graphics display when motion is detected along the aisle.

31. A display assembly according to claim 20 wherein said display assembly further comprises a timer which times out to activate the sleep circuit.

32. A display assembly according to claim 20 wherein said display assembly further comprises a product identification system whereby without human intervention a real-time inventory is taken of shelf resident products marked by remotely accessible identifiers, such identifiers comprising at least one identifier selected from the group consisting of tags, transponders and other markers which are responsive to interrogating signals from the identification system.

33. A display assembly according to claim 20 further comprising a controller remote from the display assembly and wherein said display assembly further comprises a modem and associated electronics which provide wireless communications with the remotely disposed controller.

34. A display assembly according to claim 20 wherein said graphics display comprises a liquid crystal screen.

35. A display assembly according to claim 20 wherein said display assembly further comprises two juxtaposed graphic displays oriented so that video images are seen from either direction along the aisle.

36. A method for providing automated, remotely controlled and modifiable advertising at a product-carrying shelf along an aisle of a retail store comprising the following acts:
providing a point-of-purchase advertising system comprising:
at least one programmable display assembly securely and transversely connected to the shelf such that at least a portion of the display assembly extends for visual observation of advertising into an aisle adjacent to the shelf; and
a controller, remotely disposed relative to the display assembly, said display assembly and controller, in combination, comprising a wireless data link to provide illuminated modifiable point-of-purchase advertising in close proximity to the product;
providing as a part of said display assembly, a digital processor having sufficient digital memory to store advertising displays, communications and control programs; at least one graphics display; a power supply; and a shelf-mounting system whereby the display assembly is securely affixed to the shelf;
transmitting a digital message from the controller to the display assembly, the digital message comprising at least one displayable image;
receiving the digital message at the display assembly and displaying the image on the at least one graphics display.

37. A method according to claim 36 comprising the further act of positioning the power in connected relation to the shelf such that weight of the power supply is borne by the shelf and not borne by the portion of the display assembly which extends into the aisle.

38. A method according to claim 36 comprising the further act of affixing a battery to the shelf such that the weight of the battery is not borne by the portion of the display assembly which extends into the aisle.

39. A method according to claim 36 comprising the further act of disconnecting the display assembly from one shelf position and connecting the display assembly to a second shelf position.

40. A method according to claim 36 comprising the further act of providing at least one video camera at the display assembly disposed for viewing along the aisle.

41. A method according to claim 40 comprising the further act of collecting images along the aisle and reproducing the images on the at least one graphics display at the display assembly in real time.

42. A method according to claim 41 comprising the further act of transmitting the images taken by the video camera to the controller.

43. A method according to claim 36 comprising the further act of providing a switchable sleep circuit which, when activated, substantially cuts off power to the display assembly and when deactivated resumes power to the display.

44. A method according to claim 43 comprising the further act of providing a motion detector which is disposed to sense movement along the aisle and which deactivates the sleep circuit when motion is detected along the aisle.

45. A method according to claim 44 comprising the further act of providing a timer, as part of the display assembly, the timing out of which activates the sleep circuit.

46. A method according to claim 45 comprising the further act of activating the sleep circuit when the timer times out and no motion is detected by the motion detector.

47. A method according to claim 45 further comprising the act of providing a pair of separately powered and controlled graphics displays which display in opposing directions along the aisle, one associated motion detector for each graphics display and a sleep circuit which selectively removes power from each graphics display dependent upon motion in the aisle detected by each motion detector.

48. A method according to claim 43 comprising a step of selectively applying power to that graphics display associated with detected motion by at least one motion detector.

49. A method according to claim 36 further comprising the act of providing a product identification system whereby a real-time inventory is taken of shelf resident products marked by remotely accessible identifiers, such identifiers comprising at least one identifier selected from the group consisting of tags, transponders and other markers which are responsive to interrogating signals from the identification system.

50. A method according to claim 49 further comprising the act of taking an inventory of all shelf-carried products at a particular point in time and storing results of the inventory in processor memory.

51. A method according to claim 50 comprising a step of taking a subsequent inventory shelf-carried products at a subsequent point in time to thereby determine a change in inventory.

52. A method according to claim 50 further comprising the act of transmitting the change in shelf resident inventory to the controller.

53. A method according to claim 36 comprising a step of providing a plurality of display assemblies.

54. A method according to claim 53 further comprising the act of from time-to-time transmitting different advertising images from the controller to each of the display assemblies.

55. A system for providing illuminated advertising along a shopping aisle adjacent to a shelf upon which an inventory of product is placed comprising:
a controller comprising an electronic source of advertising information and a transmitter by which the advertising information is transmitted;
at least one display assembly located remote from the controller and comprising connectors by which the display assembly is secured to the shelf, the display assembly further comprising an electronic billboard upon which the transmitted advertising information is illuminated in human readable form for visual observation by a shopper, the display assembly comprising a receiver which receives the advertising information and communicates the advertising information to the billboard for illuminated display in human readable form.

56. A system according to claim 55 wherein the transmitter and receiver are wireless communication devices.

57. A system according to claim 55 wherein the transmitter and receiver are in hard wire communication.

58. A system according to claim 55 wherein the billboard of the display assembly projects generally transversely into the aisle.

59. A system according to claim 55 wherein the billboard projects generally transversely into the aisle such that the billboard is deflectable in respect to the connectors.

60. A system according to claim 55 wherein the controller is programmable and comprises memory in which a plurality of different advertising information is stored for selective transmission to the display assembly.

61. A system according to claim 55 wherein the display assembly comprises a transmitter and the controller comprises a receiver which is in formation communication with the transmitter of the display assembly.

62. A system according to claim 55 further comprising at least one video camera carried by the display assembly, which video camera monitors visual events along the aisle.

63. A system according to claim 62 wherein the video camera communications information pertaining to the monitored aisle events for visual observation on the electronic billboard.

64. A system according to claim 55 further comprising an audio device carried by the display assembly for monitoring audio events along the aisle.

65. A system according to claim 64 comprising memory in which information pertaining to the monitored audio events is stored for future access.

66. A system according to claim 55 comprising at least one battery, disposed adjacent to the electronic billboard by which electrical power is provided to the electronic billboard.

67. A system according to claim 60 wherein the at least one battery is located under the shelf.

68. A system according to claim 55 wherein the products on the shelf each comprise a readable identifier and the display assembly comprises an inventory reader by which the identifiers are read, the system further comprising memory to which information from the inventory reader is communicated for subsequent access.

69. A method of providing advertising along a retail shopping aisle adjacent to a shelf upon which an inventory of product is placed comprising the acts of:
creating advertising information at a first site;
communicating the advertising information electronically from the first site to an electronic billboard of a display assembly mounted to the shelf at a second site remote from the first site;
displaying the advertising in human readable form on the electronic billboard in plain view of a shopper in the retail shopping aisle.

70. A method according to claim 69 further comprising the act of storing the advertising information after the creating act and before the communicating act.

71. A method according to claim 70 wherein the stored advertising information comprises a plurality of advertisements, at least one of which is communicated to the electronic billboard at a selected point in time.

72. A method according to claim 69 further comprising the act of causing the electronic billboard to physically project transversely into the retail shopping aisle.

73. A method according to claim 72 wherein the electronic billboard displays advertising to shoppers along the aisle in both directions.

74. A method according to claim 69 wherein the communication act is accomplished using technologies selected from the group consisting of wireless communications and hard wire communications.

75. A method according to claim 69 further comprising the act of discontinuing the displaying act of discontinuing the displaying act at times when a shopper is not in the aisle.

76. A method according to claim 75 further comprising the act of resuming the displaying act after the discontinuing act when a shopper is in the aisle.

77. A method according to claim 69 further comprising the act of monitoring aisle events using a video camera associated with the display assembly.

78. A method according to claim 69 further comprising the act of monitoring the supply of the product on the shelf using a reader associated with the display assembly.

79. A method according to claim 78 further comprising the act of storing in memory the results of the monitoring act.

80. A method according to claim 78 further comprising the act of communicating the results of the monitoring act to first site.

81. A method according to claim 69 further comprising the act of monitoring audio events in the aisle using an audio monitor associated with the display assembly.

82. A method of advertising a product in inventory on a retail shelf and monitoring the change in inventory, comprising the acts of:
mounting a product-advertising device fo the retail store shelf adjacent to the inventory;
displaying a form of advertising for the product at the device;
monitoring the supply of the product on the shelf using a monitoring device associated with the advertising device;
communicating the results of the monitoring act from the monitor at the device to a management retrieval location for inventory analysis and replenishment purposes.
